(19) United States
(12) Patent Application Publication
(10) Pub. No.: US 2024/0335910 A1
(43) Pub. Date: Oct. 10, 2024

(54) WELDING PHENOMENON BEHAVIOR MEASURING METHOD, MEASURING DEVICE, WELDING SYSTEM, AND PROGRAM

(71) Applicant: Kabushiki Kaisha Kobe Seiko Sho (Kobe Steel, Ltd.), Kobe-shi (JP)

(72) Inventors: Atsushi FUKUNAGA, Fujisawa-shi (JP); Takeshi KOIKE, Fujisawa-shi (JP)

(73) Assignee: Kabushiki Kaisha Kobe Seiko Sho (Kobe Steel, Ltd.), Kobe-shi (JP)

(21) Appl. No.: 18/577,795

(22) PCT Filed: May 27, 2022
(86) PCT No.: PCT/JP2022/021720

§ 371 Date: Jan. 9, 2024

(30) Foreign Application Priority Data
Jul. 19, 2021 (JP) 2021-118757

(51) Int. Cl. B23K 31/12; B23K 9/095

(52) U.S. Cl. CPC B23K 31/125; B23K 9/0956

(57) ABSTRACT

A method for measuring the behavior of a welding phenomenon includes: an image processing step for carrying out, in accordance with the behavior of a welding phenomenon of interest, image processing with respect to a welding image that has been imaged by a visual sensor; an image division step for using the processed image that has been generated in the image processing step to generate a plurality of divided images for respective constituent elements corresponding to the welding phenomenon; and a derivation step for using at least two divided images among the plurality of divided images to derive the behavior of the welding phenomenon.

### TECHNICAL FIELD

The present invention relates to a welding phenomenon behavior measuring method, a measuring device, a welding system, and a program.

### BACKGROUND ART

Gas metal arc welding (hereinafter also referred to as GMAW) produces the behaviors of various welding phenomena (hereinafter referred to as welding behaviors) that occur during welding. There are some welding behaviors, such as spatter and fumes, that can harm the welding quality, and conventionally, methods for measuring these welding behaviors have been sought for real-time welding quality determination and traceability.

As a conventional measurement method, PTL 1 discloses a spatter recognition method and a spatter recognition device that use image processing means to accurately measure the amount of spatter generated and its behavior. Specifically, during arc welding, the arc generation position and its surroundings are imaged in a plurality of frame images, each frame image is subjected to binarization or multivalue processing to extract one or more high-luminance isolated regions, and the position information of each isolated region extracted is detected. Furthermore, based on the detected position information of each isolated region, the presence of continuity of isolated regions between consecutive frame images is determined, and a group of consecutive isolated regions that are determined to be continuous are recognized as one spatter event occurring during arc welding.

In addition, PTL 2 discloses a spatter counting method performed by a portable terminal device equipped with an imaging device, which is aimed to count the spatter using a simple method while minimizing costs. Specifically, a spatter counting method is disclosed which images a video image of a region where spatter can be imaged at the time of welding, and counts the spatter imaged in each of still images constituting the video image.

### CITATION LIST

### Patent Literature

PTL 1: Japanese Unexamined Patent Application Publication No. 2008-126274
PTL 2: Japanese Unexamined Patent Application Publication No. 2019-188421

### SUMMARY OF INVENTION

### Technical Problem

However, spatter is not the only behavior that requires measurement at the time of welding. For example, fumes and molten pool shapes also need to be measured. In PTL 1 and PTL 2, spatter can be measured as the behavior of a welding phenomenon, but they do not take into consideration the simultaneous measurements of other welding behaviors. In other words, PTL 1 and PTL 2 are specialized methods designed for measuring spatter.

It is an object of the invention of the present application to provide a measuring method that enables a plurality of behaviors of welding phenomena to be measured based on a captured image imaged by a visual sensor, as well as an apparatus, system, and program thereof, a welding method using the same, and an additive manufacturing method.

### Solution to Problem

In order to solve the above problems, the invention of the present application has the following configuration. That is, there is provided a welding phenomenon behavior measuring method including:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

The invention of the present application also has, as another form, the following configuration. That is, where is provided a welding system including:
a welding device;
a visual sensor that images a welding operation by the welding device; and
a measuring device that measures the behavior of a welding phenomenon using the welding image imaged by the visual sensor,
wherein the measuring device includes:
   image processing means for carrying out, in accordance with a behavior of a welding phenomenon of interest, image processing with respect to the welding image;
   image division means for using the processed image that has been generated by the image processing means to generate a plurality of divided images for respective constituent elements corresponding to the welding phenomenon; and
   derivation means for using at least two divided images among the plurality of divided images to derive the behavior of the welding phenomenon.

The invention of the present application also has, as another form, the following configuration. That is, there is provided a welding phenomenon behavior measuring device including:
image processing means for carrying out, in accordance with a behavior of a welding phenomenon of interest, image processing with respect to a welding image that has been imaged by a visual sensor;
image division means for using the processed image that has been generated by the image processing means to generate a plurality of divided images for respective constituent elements corresponding to the welding phenomenon; and
derivation means for using at least two divided images among the plurality of divided images to derive the behavior of the welding phenomenon.

The invention of the present application also has, as another form, the following configuration. That is, there is provided a welding phenomenon behavior measuring method including:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

The invention of the present application also has, as another form, the following configuration. That is, there is provided a program causing a computer to carry out:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

### Advantageous Effects of Invention

According to the present invention, a plurality of behaviors of welding phenomena can be measured based on a captured image imaged by a visual sensor.

### BRIEF DESCRIPTION OF DRAWINGS

FIG. 1 is a schematic diagram illustrating an example of the configuration of a welding system according to an embodiment of the invention of the present application.

FIG. 2 is a schematic diagram illustrating an example of the configuration of a robot control device according to the embodiment of the invention of the present application.

FIG. 3 is a schematic diagram illustrating an example of the mechanical configuration of a data processing device according to the embodiment of the invention of the present application.

FIG. 4 is a flowchart illustrating the flow of processing according to the embodiment of the invention of the present application.

FIG. 5 is a descriptive diagram for describing the generation of each color component image according to the embodiment of the invention of the present application.

FIG. 6 is a flowchart illustrating element classification processing according to the embodiment of the invention of the present application.

FIG. 7 is a descriptive diagram for describing a case where an obstacle is included in an image.

FIG. 8 is a descriptive diagram for describing the transition of images according to the embodiment of the invention of the present application.

FIG. 9 is a descriptive diagram for describing the transition of images according to the embodiment of the invention of the present application.

### DESCRIPTION OF EMBODIMENTS

Hereinafter, embodiments of the invention of the present application will be described with reference to the drawings. Note that the embodiments described below are each one embodiment for describing the invention of the present application, and they are not intended to be construed as limiting the invention of the present application. Moreover, not all of the configurations described in each embodiment are essential configurations for solving the problems of the invention of the present application. Also, in each drawing, the same component is denoted by the same reference numeral to indicate the corresponding relationship.

In addition, a welding behavior measuring method according to the invention of the present application is useful not only in welding, but also in additive manufacturing technology utilizing GMAW, specifically wire and arc additive manufacturing (WAAM) technology. Note that the term additive manufacturing may be used in a broad sense as a term in the context of layered fabrication or rapid prototyping, but in the invention of the present application, the term additive manufacturing is consistently used. When the method according to the invention of the present application is utilized in additive manufacturing technology, “welding” is replaced with “deposition”, “additive manufacturing”, “layered fabrication”, or the like. For example, when treated as welding, the invention of the present application is for measuring a “welding behavior”; however, when the invention of the present application is utilized as additive manufacturing, the term “welding behavior” can be rephrased as “deposition behavior”. When treated as welding, the invention of the present application is a “welding system”; however, when the invention of the present application is utilized as additive manufacturing, the term “welding system” can be rephrased as “additive manufacturing system”.

### First Embodiment

Hereinafter, an embodiment according to the invention of the present application will be described with reference to the drawings.

### [Configuration of Welding System]

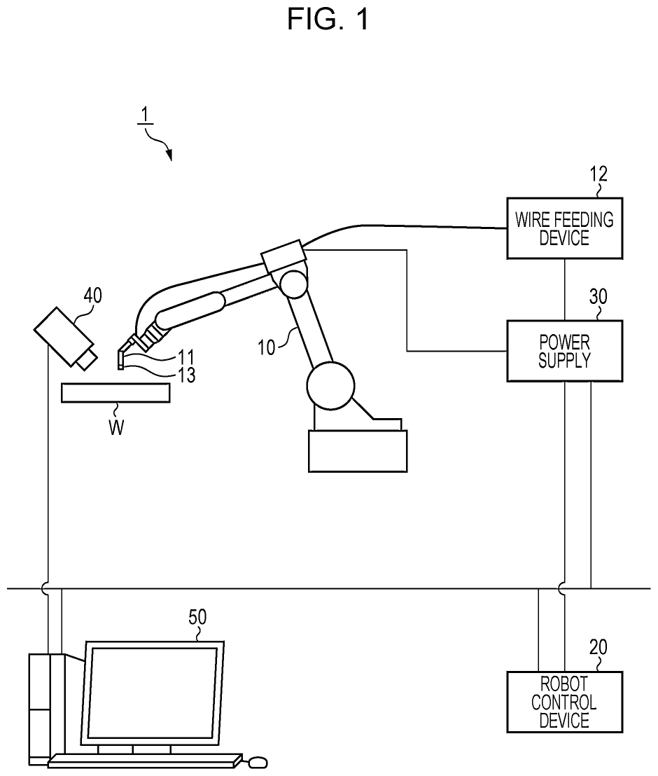

FIG. 1 illustrates an example of the configuration of a welding system 1 according to the present embodiment. The welding system 1 illustrated in FIG. 1 is configured including a welding robot 10, a robot control device 20, a power supply 30, a visual sensor 40, and a data processing device 50. In the case where the method according to the invention of the present application is used by being applied to additive manufacturing, for example, the welding system 1 may be reread as an additive manufacturing system, and the welding robot 10 may be reread as an additive manufacturing robot.

The welding robot 10 illustrated in FIG. 1 is composed of a six-axis articulated robot, and a welding torch 11 for GMAW is mounted at its tip. Note that GMAW includes, for example, MIG (Metal Inert Gas) welding and MAG (Metal Active Gas) welding, and MAG welding is described as an example in the present embodiment. Also, the welding robot 10 is not limited to a six-axis articulated robot, and, for example, a portable small robot may be employed.

Welding wire 13 is supplied from a wire feeding device 12 to the welding torch 11. The welding wire 13 is fed from the tip of the welding torch 11 towards the welding spot. The power supply 30 supplies power to the welding wire 13. With this power, an arc voltage is applied between the welding wire 13 and a workpiece W, which generates an arc. The power supply 30 is provided with a non-illustrated current sensor that detects a welding current flowing from the welding wire 13 during welding to the workpiece W, and a non-illustrated voltage sensor that detects an arc voltage between the welding wire 13 and the workpiece W.

The power supply 30 has a processing unit and a storage unit, which are not illustrated. The processing unit is configured of, for example, a CPU (Central Processing Unit). In addition, the storage unit is configured of volatile and/or non-volatile memory such as, for example, HDD (Hard Disk Drive), ROM (Read Only Memory), and RAM (Random Access Memory). The processing unit controls the power applied to the welding wire 13 by executing a computer program for power control stored in the storage unit. The power supply 30 is also connected to the wire feeding device 12, and the processing unit controls the feeding speed and the feeding amount of the welding wire 13.

The composition and type of the welding wire 13 used are selected according to the welding target. Note that the welding behaviors according to the present embodiment include, in addition to spatter and fumes described above, arc deflection, arc pressure, the amount of oxide coverage on the molten pool, droplet transfer mode, droplet detachment cycle, short-circuit frequency, and the occurrence of welding defects such as pits.

The visual sensor 40 is configured of, for example, a CCD (Charge Coupled Device) camera. The position at which the visual sensor 40 is located is not particularly limited; the visual sensor 40 may be directly attached to the welding robot 10, or may be fixed as a surveillance camera at a specific location in the surroundings. In the case where the visual sensor 40 is directly attached to the welding robot 10, the visual sensor 40 moves to image the surroundings of the tip of the welding torch 11 in conjunction with the operation of the welding robot 10. The number of cameras constituting the visual sensor 40 may be plural.

In addition, the direction of imaging by the visual sensor 40 is not particularly limited; for example, in the case where the direction in which welding progresses is considered as forward, the visual sensor 40 may be arranged to image the forward side, or may be arranged to image the lateral side or the back side. Therefore, the range of imaging by the visual sensor 40 may be appropriately determined according to the welding behavior of the measurement target. In the case where the target is spatter or fumes, it is preferable to image the target from the forward side in order to suppress interference of the welding torch 11.

In the present embodiment, the visual sensor 40 fixed at a specific location is used to image a video image as a welding image so that the imaging range includes the workpiece W, the welding wire 13, and an arc. Note that various imaging settings pertaining to the welding image may be specified in advance, or may be switched according to the operating conditions of the welding system 1. As for the imaging settings, examples include frame rate, image pixel count, resolution, shutter speed, and the like.

The individual sections of the welding system 1 are communicatively connected by various wired and/or wireless communication methods. The communication methods here are not limited to one, and the sections may be connected using a combination of multiple communication methods.

### [Configuration of Robot Control Device]

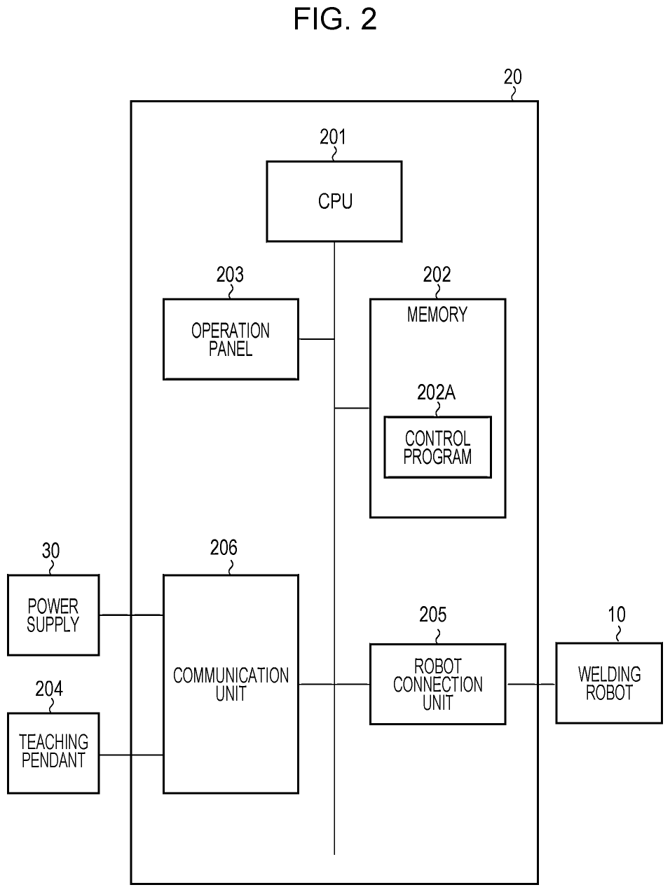

FIG. 2 illustrates an example of the configuration of the robot control device 20, which controls the operation of the welding robot 10. The robot control device 20 is configured including a CPU 201 which controls the entire device, a memory 202 which stores data, an operation panel 203 including a plurality of switches, a teaching pendant 204 for use in teaching tasks, a robot connection unit 205, and a communication unit 206. The memory 202 is configured of volatile and/or non-volatile storage devices such as ROM, RAM, HDD, etc. The memory 202 stores a control program 202A for use in controlling the welding robot 10. By executing the control program 202A, the CPU 201 controls various operations performed by the welding robot 10.

The teaching pendant 204 is primarily used for inputting instructions to the robot control device 20. The teaching pendant 204 is connected to the body of the robot control device 20 via the communication unit 206. The operator may input a teaching program using the teaching pendant 204. The robot control device 20 controls the welding operation of the welding robot 10 in accordance with the teaching program input from the teaching pendant 204. Note that the teaching program may also be created automatically, for example, using a non-illustrated computer, based on CAD (Computer-Aided Design) information or the like. The operation content defined in the teaching program is not particularly limited, and may differ depending on the specification and welding method of the welding robot 10.

A drive circuit of the welding robot 10 is connected to the robot connection unit 205. The CPU 201 outputs a control signal based on the control program 202A to the non-illustrated drive circuit included in the welding robot 10 via the robot connection unit 205.

The communication unit 206 is a communication module for wired or wireless communication. The communication unit 206 is used for data communication with the power supply 30 and the data processing device 50. There are no specific restrictions on the communication methods and standards used by the communication unit 206, and multiple methods may be combined. The power supply 30 provides, for example, the current value of the welding current detected by the non-illustrated current sensor or the voltage value of the arc voltage detected by the non-illustrated voltage sensor to the CPU 201 via the communication unit 206.

The robot control device 20 also controls the movement speed and protrusion direction of the welding torch 11 by controlling each axis of the welding robot 10. Moreover, the robot control device 20 also controls the weaving motion of the welding robot 10 according to the set cycle, amplitude and welding speed. The weaving motion refers to alternating oscillations of the welding torch 11 in a direction that intersects with the direction in which welding progresses. The robot control device 20 performs welding line simulating control along with the weaving motion. The welding line simulating control is an operation for controlling the left and right positions with respect to the direction in which the welding torch 11 progresses so that beads will be formed along the welding line. Furthermore, by controlling the wire feeding device 12 via the power supply 30, the robot control device 20 also controls the feeding speed of the welding wire 13.

### [Configuration of Data Processing Device]

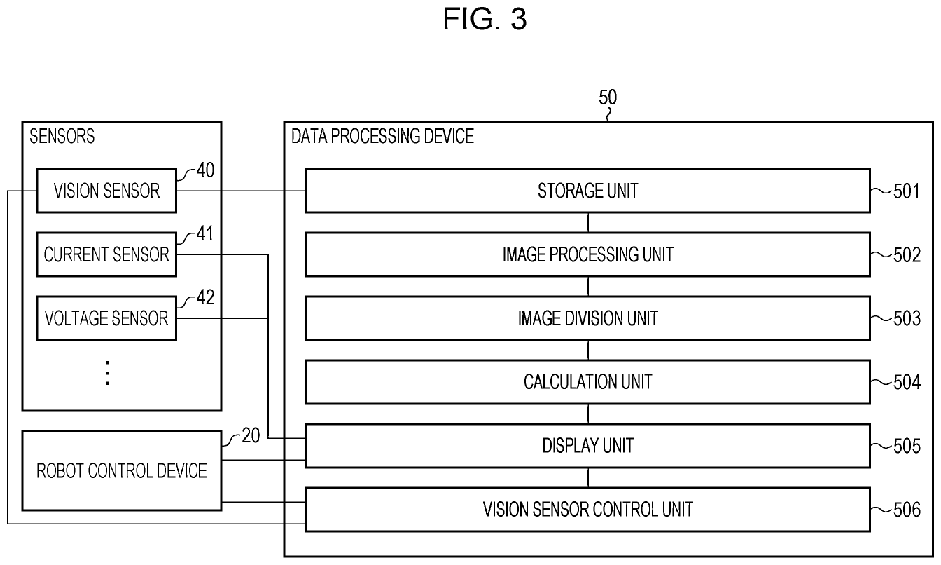

FIG. 3 is a diagram for describing an example of the functional configuration of the data processing device 50. The data processing device 50 is configured of, for example, a CPU, ROM, RAM, hard disk device, input/output interface, communication interface, video output interface, etc. which are not illustrated. The above-mentioned components cooperate with one another, allowing the data processing device 50 to realize a storage unit 501, an image processing unit 502, an image division unit 503, a calculation unit 504, and a display unit 505. Also, in the case where the visual sensor 40 is a fixed surveillance camera, the data processing device 50 further includes a visual sensor control unit 506. Note that the sequence of steps performed by the image processing unit 502, the image division unit 503, the calculation unit 504, and the display unit 505 may be performed by software installed on the data processing device 50.

The storage unit 501 records and manages image data imaged by the visual sensor 40 and provides the image data in response to a request from each processing unit. The image data mentioned here may be still image data, or data of a video image imaged by continuously imaging still image data at an arbitrary frame rate. The frame rate mentioned here indicates the number of pieces of still image data imaged by the visual sensor 40 at a certain time interval, such as, for example, one second. Preferably, the time interval is determined in the range of 1 to 10 FPS (Frames Per Second). Note that it is preferable to record the data as a video image in the case where the data is used for real-time measurement of welding behavior and traceability.

The image processing unit 502 performs pre-processing for the measurement according to the present embodiment using the image data stored in the storage unit 501. As for the pre-processing, examples include contrast correction, brightness correction, color correction, monochrome image conversion such as binarization, noise removal, edge enhancement, contraction/expansion, image feature extraction, and the like. Specific examples of image processing according to the present embodiment will be described later.

The image division unit 503 creates divided images through division into multiple images for respective constituent elements determined in advance, based on the processed image data that has undergone various types of image processing in the image processing unit 502. Note that the constituent elements determined in advance include spatter, fumes, and arc light as welding behaviors, the welding wire 13, nozzle, base metal, molten pool, and obstacle, which are the composition of the welding system 1, and background as others. Here, the description will be given by focusing on spatter, fumes, and arc light. Note that the processing performed by the image processing unit 502 is not limited to pre-processing for generating divided images in the image division unit 503. If necessary, the image processing unit 502 may perform processing on the divided images.

The calculation unit 504 calculates various indicator values for quantitatively measuring spatter, fumes, and arc light as welding behaviors based on the divided images and the processed image data. The calculations here are preferably performed, for example, in chronological order. As for being in chronological order mentioned here, examples include elapsed time, the order of teaching program steps, the sequence of consecutive pieces of still image data constituting a video image, and the like.

The display unit 505 displays a screen configured based on a calculation result obtained by the calculation unit 504. In addition, the display unit 505 displays on the screen the values detected by a current sensor 41 and a voltage sensor 42, as well as various types of information obtained from the robot control device 20. It is preferable to display the results calculated chronologically by the calculation unit 504 in synchronization with the chronological order of data such as welding current and arc voltage, for example.

The visual sensor control unit 506 controls imaging operations of the visual sensor 40. For example, in the case where the visual sensor 40 is a sensor mounted on somewhere other than the welding robot 10, it is preferable to employ a camera with at least PTZ (Pan, Tilt, Zoom) functionality as the visual sensor 40, and the pan, tilt, and zoom functions may be controlled in conjunction with the movements of the welding robot 10. The visual sensor control unit 506 may also obtain information about the movements of the welding robot 10 from the robot control device 20, and control the operation of the visual sensor 40 based on the information.

### [Measuring Method]

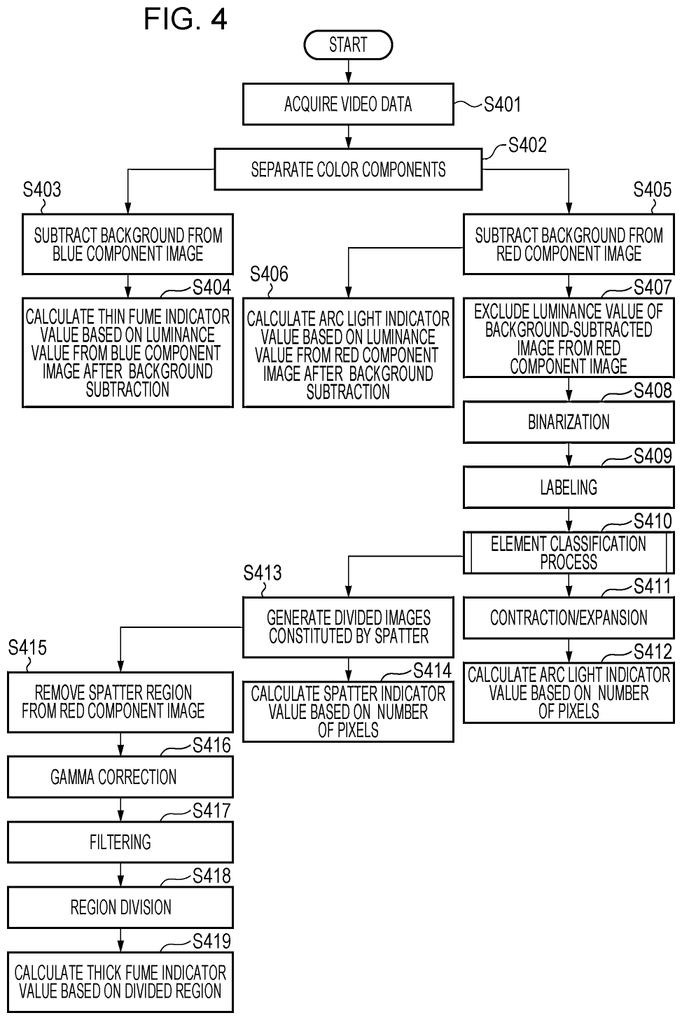

FIG. 4 is a diagram for describing the flow of a sequence when measuring a plurality of welding behaviors from image data. Although FIG. 4 illustrates sequential processing for measuring spatter, fumes, and arc light, which are examples of welding behaviors, all of them need not be measured, and only some of them may be measured. Also, in FIG. 4, for example, multiple indicator values are calculated for one welding behavior, but all of the indicator values need not be measured, and it may be switched to calculate one indicator value for one welding behavior. Although the present embodiment is an example in which video data after the end of welding is processed for the purpose of traceability, the processing is not limited to one after the end of welding, and the following processing may be performed in parallel with the welding operation, that is, in real time.

The processing flow in FIG. 4 may be realized by the processing unit of the data processing device 50, which measures a welding behavior in parallel with a welding operation or by using an image imaged during welding, by reading and executing a program stored in the storage unit to enable the sections illustrated in FIG. 3 to function.

In S401, the data processing device 50 acquires video data to be processed. Here, imaging conditions such as frame rate, shutter speed, etc. are set in the visual sensor 40, and the visual sensor 40 images, as video data, a range around the welding position to be imaged. The imaging conditions may be set to any values by the operator, or fixed values specified in advance may be used. The imaged video data may be stored directly in the storage unit 501 of the data processing device 50. In the case where the visual sensor 40 itself has memory, the video data may be once stored in the memory of the visual sensor 40, and then transferred to the storage unit 501. Note that the subsequent processing is performed on each of the plurality of pieces of still image data included in the video data.

In S402, the data processing device 50 performs color component separation processing on the acquired video data. The video data according to the present embodiment is composed of, for example, color images composed of RGB signals, where each pixel represents the red, green, and blue color components. The RGB signals represent, for example, each color component with 8 bits, resulting in a total of 24 bits per pixel. In this case, the signal value corresponding to each color component takes a value from 0 to 255. The color component separation processing here focuses on each color component, and creates video data separated into the color components for RGB. In other words, a single piece of video data is divided into pieces of video data, each containing only the R color component, only the G color component, and only the B color component. More specifically, in the case of generating video data containing only the R color component, the color component separation processing is performed by converting the signal values of G and B of the video data to 0.

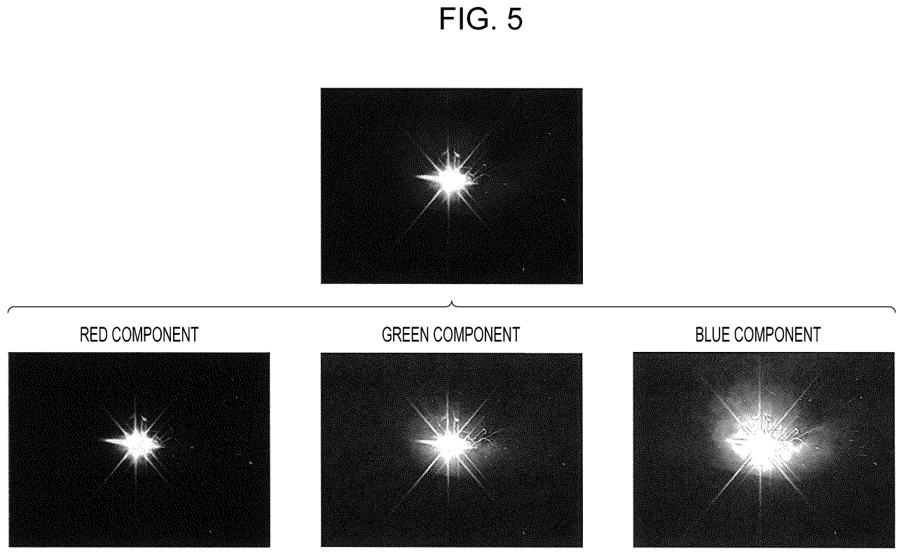

FIG. 5 is a diagram for describing the generation of pieces of video data, each containing only the R, G, or B color component, from the video data. As illustrated in FIG. 5, pieces of still image data, each containing only the respective color component, generated from a single piece of still image data included in the video data, each have different representations, and hence, even if the same welding behavior has occurred, different characteristics are captured. Hereinafter, still image data containing only the R color component, still image data containing only the G color component, and still image data containing only the B color component will be referred to as a “red component image”, a “green component image”, and a “blue component image”, respectively.

The inventors of the present application have discovered through experimentation and verification that a blue component image can be clearly discerned in relation to thermal energy light. Thermal energy light is a phenomenon associated with arc light or fumes. In other words, by using a blue component image, it is possible to extract light with faint shading out of the thermal energy light, and, based on this faint light, fumes spreading in the surroundings, which were previously difficult to extract, can be calculated.

In addition, the inventors of the present application have discovered through experimentation and verification that a red component image can be clearly discerned in high-temperature luminescence of metals, slags, and the like. In other words, by using a red component image, it is possible to capture spatter, a molten pool, or fumes with a high particle density based on the high-temperature luminescence contained therein. Hereinafter, fumes with a high particle density on the image are described as “thick fumes”, and fumes with a low particle density are described as “thin fumes”. Note that the terms “thick” and “thin” here are used relatively, and their concentration values are not restricted.

By performing the separation processing into the R, G, and B components, the feature extraction of various welding behaviors is facilitated. Note that the present embodiment describes an example of measuring a welding behavior using a red component image and a blue component image. However, the present embodiment is not limited to this example, and a welding behavior may be measured by further using a green component image. For example, a green component image may be used in the region identification of constituent elements described later.

Although the present embodiment describes the color space of RGB as an example, this is not the only possible color space. For example, other color spaces that can be converted corresponding to the individual parameters of R, G, and B may be used. More specifically, color spaces that can be used include RGBA, YCbCr, YUV, etc.

First, the calculation of an indicator value for measuring thin fumes using a blue component image will be described. In S403, the data processing device 50 applies background subtraction processing to the blue component image using the image processing unit 502. There are no specific restrictions on the method of the background subtraction processing, and, for example, background subtraction may be performed by removing noise using the known rolling-ball algorithm. Alternatively, the background subtraction processing may be performed by filtering processing using a certain filter. Through the processing of this step, a spike-like signal is removed to obtain pixel values that fluctuate smoothly. In the present embodiment, the smoothly-fluctuating pixel values are treated as being derived from thin fumes.

In S404, the data processing device 50 calculates, using the calculation unit 504, the total luminance value as the indicator value of thin fumes in the blue component image that has undergone the background subtraction processing in S403. Here, the sum of weighted values based on each luminance in the luminance histogram represented by the entire blue component image may be calculated as the indicator value.

Next, an indicator value for measuring arc light and thick fumes using a red component image will be described. In S405, the data processing device 50 applies background subtraction processing to the red component image using the image processing unit 502. There are no specific restrictions on the method of the background removal processing, and, for example, as in the processing of S403, background subtraction may be performed by removing noise using the known rolling-ball algorithm. Alternatively, the background subtraction processing may be performed by filtering processing using a certain filter. Through the processing of this step, a spike-like signal is removed to obtain pixel values that fluctuate smoothly.

In S406, the data processing device 50 calculates, using the calculation unit 504, the total luminance value as the indicator value of arc light in the red component image that has undergone the background subtraction processing in S405. Here, the sum of weighted values based on each luminance in the luminance histogram represented by the entire red component image may be calculated as the indicator value.

In S407, the data processing device 50 excludes, using the image processing unit 502, the luminance value of the background-subtracted red component image generated in S405, from the luminance value of each pixel of the red component image generated in S402. Through the processing of this step, the smoothly-fluctuating pixel values can be excluded in the red component image.

In S408, the data processing device 50 performs, using the image processing unit 502, binarization processing on the red component image after the processing in S407 to generate a binarized image. There are no specific restrictions on the method of the binarization processing, and a known method may be used. Also, there are no specific restrictions on the setting of a threshold for the binarization processing, and, for example, the median value among the possible pixel values may serve as the threshold.

In S409, the data processing device 50 performs, using the image processing unit 502, labeling processing for each region included in the image using the binarized image generated in S408. The binarized image includes a plurality of regions each composed of one or more pixels, and each region is extracted. In the present embodiment, in the binarized image, each region composed of one or more pixels with the pixel value “1” is labeled as a region corresponding to any of the constituent elements that occur as a result of a welding behavior. There are no specific restrictions on the method of the labeling processing, and a known method may be used. Also, there are no specific restrictions on the lower limit of the size of each region, and, for example, the smallest region may be a region composed of one pixel. Note that, in the case where a region composed of one or more pixels with the pixel value “0” corresponds to a constituent element that occurs as a result of a welding behavior, it may be labeled as such.

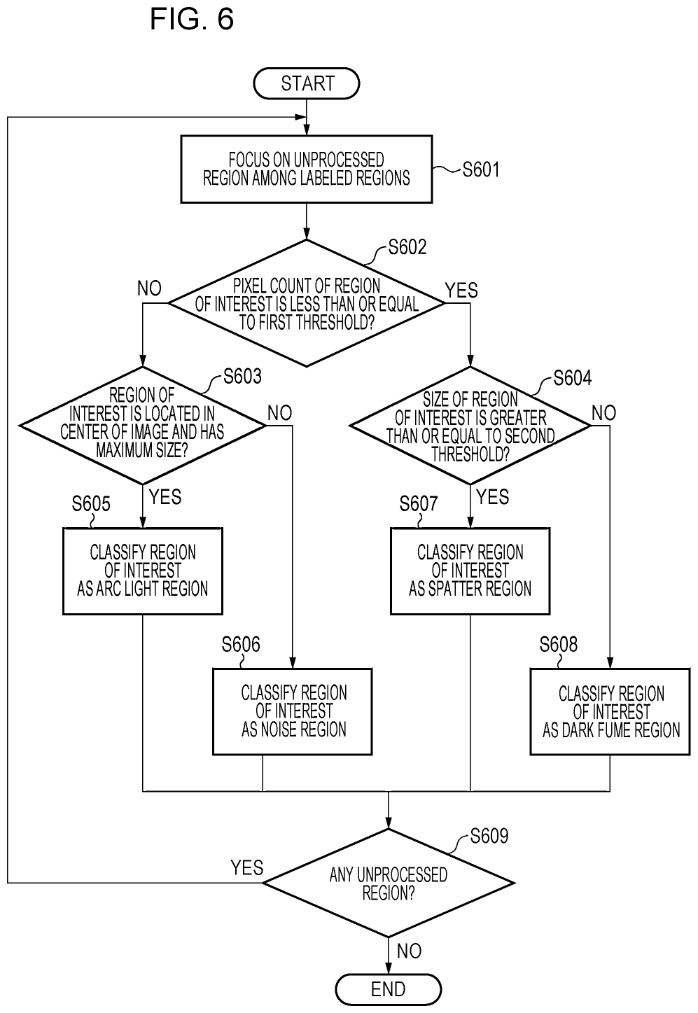

In S410, the data processing device 50 performs, using the image division unit 503, element classification processing on each region in the image labeled in S409. Details of this step will be described using FIG. 6. This step is performed each time based on the result of the labeling processing performed using each of a plurality of red component images to be processed.

In S601, the image division unit 503 focuses on an unprocessed region among one or more labeled regions included in the binarized image. At this time, there are no specific restrictions on the order of focusing, and, for example, the regions may be sorted in descending order based on their sizes, and then the larger ones may be focused first.

In S602, the image division unit 503 determines whether the pixel count of the region of interest is less than or equal to a first threshold. The first threshold here will be described as 300 pixels. Note that the first threshold may be specified according to the entire size of the red component image or may be changed according to the welding situation. For example, in the case where the visual sensor 40 is a fixed-position surveillance camera, because the welding position changes, that is, the distance between the position of the visual sensor 40 and the welding position changes, or the imaging direction and the imaging angle change, the size of the imaging target changes. Accordingly, the relationship between distance, direction, and object size may be provided in advance, and the first threshold may be changed based on this relationship. In contrast, the magnification on the camera side may be changed in order to keep the size of the imaging target constant, that is, to maintain the first threshold constant, even if the distance between the position of the visual sensor 40 and the welding position changes. In the case where the pixel count of the region of interest is less than or equal to the first threshold, that is, in the case of YES in S602, the processing of the image division unit 503 proceeds to S604. In contrast, in the case where the pixel count of the region of interest is greater than the first threshold, that is, in the case of NO in S602, the processing of the image division unit 503 proceeds to S603.

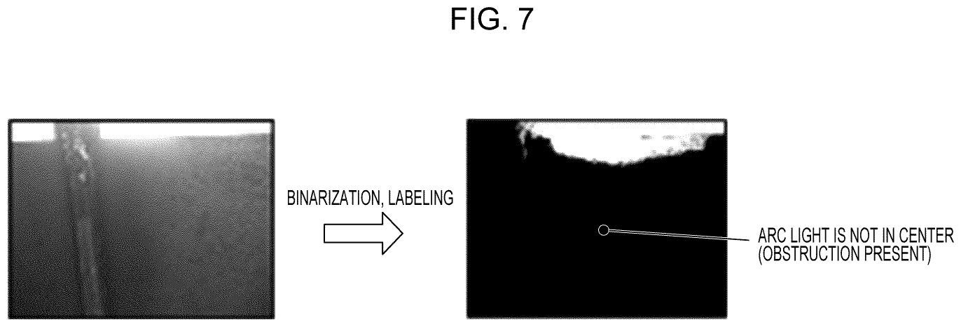

In S603, the image division unit 503 determines whether the region of interest is located in the center of the image and has the maximum size among the labeled regions. In other words, in an image capturing a normal welding behavior, arc light is located in the center, and a region of arc light is the largest region in the image. In contrast, there may be cases where arc light is not in the center as a result of an obstacle or the like appearing in the image during imaging. In such cases, the region of interest is treated as noise. FIG. 7 illustrates an example of an obstacle appearing on the image. In such cases, the resulting image is one with the arc light not located in the center. Note that the term “center” here may have a pre-set range and can vary depending on the image size, welding behavior, or the like. In addition, the maximum size used in the determination in this step differs from image to image because it is a relative size among the regions in the image. In the case where the region of interest meets the above conditions, that is, in the case of YES in S603, the processing of the image division unit 503 proceeds to S605. In contrast, in the case where the region of interest does not meet the above conditions, that is, in the case of NO in S603, the processing of the image division unit 503 proceeds to S606.

In S604, the image division unit 503 determines whether the size of the region of interest is greater than or equal to a second threshold. The second threshold is set by specifying a minimum rectangular region encompassing the region of interest, and the second threshold is set as the ratio of the pixel count of the region of interest to the pixel count of that rectangular region. Thus, the size of the rectangular region varies depending on the size of each region of interest. The second threshold here is described as 15%. In other words, the determination in this step determines whether the following condition is met:

second threshold≤(size of region of interest)/(size of rectangular region encompassing region of interest)

In the case where the size of the region of interest is greater than or equal to the second threshold, that is, in the case of YES in S604, the processing of the image division unit 503 proceeds to S607. In contrast, in the case where the size of the region of interest is less than the second threshold, that is, in the case of NO in S604, the processing of the image division unit 503 proceeds to S608.

In S605, the image division unit 503 classifies the region of interest as a region of arc light. The processing of the image division unit 503 then proceeds to S609.

In S606, the image division unit 503 classifies the region of interest as a region of noise. The processing of the image division unit 503 then proceeds to S609.

In S607, the image division unit 503 classifies the region of interest as a region of spatter. The processing of the image division unit 503 then proceeds to S609.

In S608, the image division unit 503 classifies the region of interest as a region of thick fumes. The processing of the image division unit 503 then proceeds to S609.

In S609, the image division unit 503 determines whether there is an unprocessed region. In the case where there is an unprocessed area, that is, in the case of YES in S609, the processing of the image division unit 503 returns to S601 to repeat the processing. In contrast, in the case where there is no unprocessed region, that is, in the case of NO in S609, the processing flow ends and proceeds to S411 in FIG. 4.

Referring back to FIG. 4, the operation of calculating an indicator value of arc light will be described. In S411, the data processing device 50 generates a binarized image composed of a region classified as arc light by the element classification processing described using FIG. 6. This binarized image may be generated by extracting a region classified as arc light from the binarized image labeled in S409. The binarized image at this time includes a constituent element corresponding to flare. Flare is the light generated by reflection within the lenses or camera included in the visual sensor 40. Accordingly, the data processing device 50 performs, using the image division unit 503, contraction and expansion processing on the generated binarized image in order to remove the constituent element of flare. A known method may be used for the contraction and expansion processing. In order to properly remove the constituent element of flare, the contraction processing and the expansion processing may be performed multiple times, and there are no specific restrictions on the processing order thereof.

In S412, the data processing device 50 calculates, using the calculation unit 504, an indicator value of arc light using the binarized image processed in S411. The calculation unit 504 counts the number of pixels in the region of arc light included in the binarized image, and uses that value as the indicator value.

Note that the processing in S406 calculates an indicator value of arc light based on the luminance value, and the processing in S412 calculates an indicator value of arc light based on the pixel count. They may be treated as separate indicator values, or one indicator value of the entire arc light may be derived from these two indicator values mentioned above. In addition, the arc width, arc length, arc deflection direction, and the like may further be calculated as indicator values for arc light based on the area, centroid, principal axis angle, and the like of the region of arc light.

Next, the operation of calculating an indicator value of spatter will be described. In S413, the data processing device 50 generates, using the image processing unit 502, a red component image composed of a region classified as spatter in the element classification processing of FIG. 6 using the red component image after the processing in S407.

In S414, the data processing device 50 calculates, using the calculation unit 504, an indicator value of spatter using the red component image generated in S413. First, the calculation unit 504 removes, among the regions of spatter included in the red component image, a region whose area is greater than or equal to a certain threshold, that is, a region whose pixel count is greater than or equal to a certain threshold. This is performed by assuming that each spatter particle or droplet is smaller than a certain size, and considering and removing that region as background. The threshold here is not particularly limited, and is assumed to be specified in advance. Next, the calculation unit 504 identifies the remaining spatter regions and calculates the pixel count thereof and the number of regions composed of the specified pixels as indicator values for spatter. At this time, when counting the pixel count, only the pixels with an R value greater than or equal to a certain threshold may be counted.

Note that, when calculating an evaluation value here, the corresponding relationship between the measured amount of spatter generated and the calculated value from the image obtained in the present embodiment may be defined in advance using an equation, table, etc., and they may be used to derive an indicator value. In this case, an equation and/or a table may be used to convert the calculated value from the image into a spatter amount indicating the weight per unit of time.

Next, the operation of calculating an indicator value of thick fumes will be described. In S415, the data processing device 50 generates, using the image processing unit 502, a spatter-removed image by subtracting the value of the region of spatter generated in S413 from the image generated in S407.

In S416, the data processing device 50 performs, using the image processing unit 502, gamma correction on the image generated in S415. By converting the luminance values through gamma correction, a region of small luminance values within the image is excluded. The threshold for a region to be excluded is not particularly limited, and is assumed to be specified in advance here. Also, a known method may be used for gamma correction, and there is no specific restrictions on the configuration of a gamma curve, for example.

In S417, the data processing device 50 performs, using the image processing unit 502, filtering processing on the image processed in S416. Through the filtering processing, edges in the image are detected, emphasizing portions where the luminance value gradient is steep. Although a Laplacian filter, for example, may be used for the filtering processing here, other filters may be used.

In S418, the data processing device 50 performs, using the image processing unit 502, region division based on the luminance gradient on the image to which the filtering processing has been applied in S417. The region division processing here is performed, for example, using the watershed algorithm. The watershed algorithm makes it possible to more finely divide and emphasize portions with high and low luminance, that is, portions with steep gradients in shading. Note that there are not specific restrictions on the region division method used, and other methods may be used.

In S419, the data processing device 50 calculates, using the calculation unit 504, an indicator value of thick fumes based on the image generated in S418. In the processing in S418, the image is divided into a plurality of regions. At this time, the greater the number of smaller divided regions, the more variations in shades there will be. In the present embodiment, regions with a greater variety of shades, that is, divided regions with an area equal to or less than a predetermined value, are considered as locations where thick fumes are generated, and the total area is then assumed to serve as an indicator value representing thick fumes. In the present embodiment, equation (1) below is used to derive an indicator value of thick fumes. In equation (1) below, Tₙ represents the area of the divided region n, that is, the pixel count (n=1, . . . , i):

$$\\ \begin{matrix}[ Math . 1 ] & \\ ( indicator value of thick fumes ) = \sum \frac{1}{log ( {T}_{n} )} & ( 1 )\end{matrix}$$

Note that, when calculating an evaluation value here, the corresponding relationship between the measured amount of fumes generated and the calculated value from the image obtained in the present embodiment may be defined in advance using an equation, a table, etc., and they may be used to derive an indicator value. In this case, an equation and/or a table may be used to convert the measured value from the image into a fume amount indicating the weight per unit of time.

In addition, the processing in S404 calculates an indicator value of thin fumes, and the processing in S419 calculates an indicator value of thick fumes. They may be treated as separate indicator values, or one indicator value of the whole fumes may be derived from these two indicator values mentioned above using a certain conversion formula.

After deriving each of the indicator values described above, the data processing device 50 displays them on a non-illustrated screen using the display unit 505. At this time, it is advisable to display a plurality of welding behaviors identified by the calculated indicator values, including spatter and fumes, in chronological order. Not only the calculated results of the indicator values for these welding behaviors, but also the welding current, arc voltage value, and the like may be synchronized in chronological order and displayed side by side, allowing the comparison targets to be easily visible.

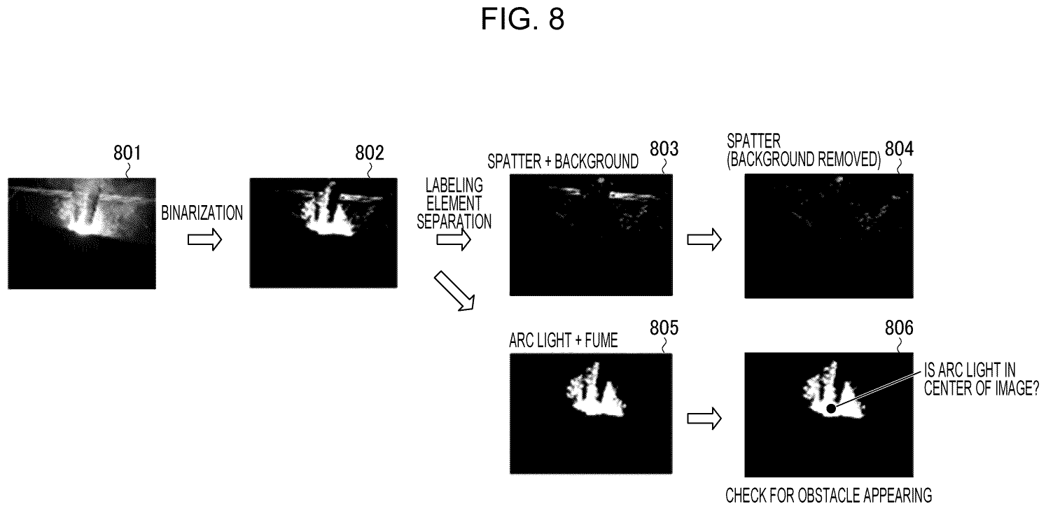

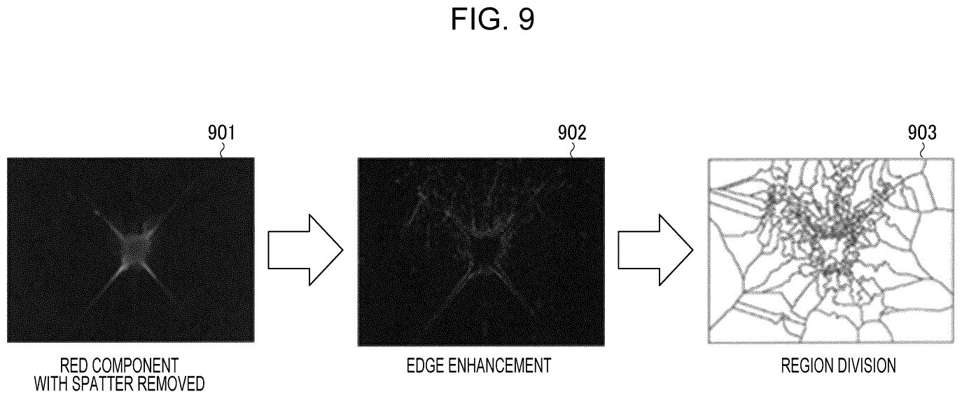

FIGS. 8 and 9 are diagrams for describing the transition of images through image processing in the above-described processing. FIG. 8 illustrates the transition of images until images for the respective constituent elements are generated from a red component image, corresponding to image processing through the processing in S405 to S415 within the processing sequences of FIG. 4.

An image 801 represents an example of a red component image, which is an image after color component separation processing. An image 802 represents an image after applying binarization processing to the image 801. Images 803 and 805 represent images generated for the respective constituent elements by applying labeling processing and element separation processing to the image 802. The image 803 is an image composed of a region classified as spatter and corresponds to the image generated in S411. The image 805 is an image composed of a region classified as arc light and corresponds to the image generated in S415.

An image 804 is an image obtained by removing a region regarded as the background from the image 803, and corresponds to the image generated in S414. An image 806 represents the case where no obstacle appears in the image 805. In the case where an obstacle is appearing as illustrated in FIG. 7, there is no region classified as arc light in the center of the image. In contrast, the image 806 will have a region classified as arc light in the center of the image.

FIG. 9 illustrates the transition of images from a red component image to region division, corresponding to image processing through the processing in S415 to S418 within the processing sequence of FIG. 4.

An image 901 represents an example of a red component image with a spatter region removed, corresponding to the image generated in S415. An image 902 is an image obtained by applying gamma correction and filtering processing to the image 901, and corresponds to the image after the processing in S417. An image 903 is an image obtained by applying region division to the image 902, and corresponds to the image after the processing in S418.

Note that, as illustrated in the flow of S402, S405, and S408 in FIG. 4, it is more preferable to perform the processing in the order of color processing, background subtraction processing (processing for smoothness), and binarization processing. This makes it possible to properly detect a region of welding behavior included in the image.

As described above, in the present embodiment, indicator values corresponding to a plurality of welding behaviors that occur during welding can be calculated based on an image. In particular, fumes with shades and spatter, which have been difficult to detect in the past, can also be detected. This makes it possible to measure a plurality of behaviors of welding phenomena based on a captured image imaged by the image sensor. In particular, although it has been difficult to measure spatter and fumes at the same time using conventional methods, the method of the present embodiment makes it possible to measure a plurality of behaviors including these behaviors.

### Other Embodiments

The above-described configuration may further be configured to be able to set the measurement time. For example, in video data of a certain length of time, the configuration may be one capable of specifying a time period to be measured within this certain length of time. Then, within this time period, the pixels and luminance values of fumes, spatter, and arc light may be counted to calculate their indicator values. This makes it possible to check welding behaviors while considering the welding conditions within a certain time period, for example.

Moreover, the above-described configuration may be configured to control the operation of the welding robot 10 and/or the visual sensor 40 based on measurement results, that is, indicator values corresponding to the individual welding behaviors. For example, the imaging settings of the visual sensor 40 may be switched, or various welding parameters of the welding robot 10 may be controlled. This makes it possible to allow the welding robot 10 to operate more properly, for example, in accordance with the occurrence of welding behavior.

In addition, a program or an application for implementing the functions of one or more embodiments described above can be supplied to a system or a device using a network or a storage medium, and one or more processors in the computer of the system or device can read and execute the program to implement the function(s).

The function(s) may be implemented by a circuit implementing one or more functions. Note that, as for a circuit implementing one or more functions, examples include ASIC (Application Specific Integrated Circuit) and FPGA (Field Programmable Gate Array).

As described above, the following matters are disclosed in the present specification.

(1) A welding phenomenon behavior measuring method including:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

According to this configuration, it is possible to measure a plurality of behaviors of welding phenomena based on a captured image imaged by the image sensor.

(2) The welding phenomenon behavior measuring method according to (1), wherein:
the constituent elements corresponding to the welding phenomenon include at least two of spatter, fumes, arc light, a molten pool, background, or an obstacle.

According to this configuration, at least two of spatter, fumes, arc light, a molten pool, background, or an obstacle can be detected as the constituent elements corresponding to the welding phenomenon.

(3) The welding phenomenon behavior measuring method according to (1) or (2), wherein:
the image division step includes:
   a labeling step for performing labeling processing on pixels included in the processed image; and
   a classification step for classifying each of one or more regions composed of a group of pixels labeled in the labeling step into a constituent element corresponding to the welding phenomenon, and
the classification step includes at least one of:
   a step for classifying each of the one or more regions into a constituent element corresponding to the welding phenomenon based on pixel count;
   a step for classifying each of the one or more regions into a constituent element corresponding to the welding phenomenon based on a position and a size; or
   a step for classifying a region of interest into a constituent element corresponding to the welding phenomenon based on a ratio of a group of pixels constituting the region of interest to a rectangular region encompassing the region of interest.

According to this configuration, it is possible to properly classify each region corresponding to the welding phenomenon included in the image.

(4) The welding phenomenon behavior measuring method according to any of (1) to (3), wherein:
in the image division step, a divided image composed of a region of spatter and a divided image composed of a region of fumes are at least generated among the constituent elements corresponding to the welding phenomenon.

According to this configuration, it is possible to separately detect spatter and fumes, each of which is a type of welding behavior.

(5) The welding phenomenon behavior measuring method according to any of (1) to (4), wherein:
in the derivation step, an indicator value of at least one of spatter or fumes is derived as the behavior of the welding phenomenon.

According to this configuration, it is possible to measure the behavior of spatter and fumes.

(6) The welding phenomenon behavior measuring method according to (5), wherein:
in the derivation step, in a case of deriving an indicator value of fumes,
an edge is detected for a divided image with a region of spatter removed,
the divided image is divided into a plurality of regions based on the detected edge, and
an indicator value of the fumes is calculated based on an area of the plurality of regions.

According to this configuration, it is possible to properly measure fumes as a welding phenomenon.

(7) The welding phenomenon behavior measuring method according to (5), further including:
a setting step for setting a period to be measured,
wherein the image processing step, the image division step, and the derivation step are performed using a welding image included in a period set in the setting step.

According to this configuration, it is possible to measure the welding behavior in a desired time range.

(8) The welding phenomenon behavior measuring method according to any of (1) to (7), wherein:
the image processing step includes at least one of processing to separate the welding image into images for respective color components, binarization processing, or processing to obtain or exclude smoothly fluctuating pixel values.

According to this configuration, it is possible to apply, as image processing when measuring the welding behavior, one of the color separation processing, the binarization processing, and the specific pixel value excluding processing.

(9) The welding phenomenon behavior measuring method according to (8), wherein, in the processing to separate the welding image into images for respective color components, color component images for respective color components of R, G, and B are generated from the welding image.

According to this configuration, it is possible to generate and utilize the respective color component images of R, G, and B to measure the welding behavior of interest.

(10) The welding phenomenon behavior measuring method according (9), wherein an indicator value of at least one of arc light, spatter, or thick fumes is derived using the color component image of R.

According to this configuration, it is possible to measure one of arc light, spatter, and thick fumes by using a color component image of R.

(11) The welding phenomenon behavior measuring method according to (9) or (10), wherein an indicator value of thin fumes is derived using the color component image of B.

According to this configuration, it is possible to measure thin fumes by using a color component image of B.

(12) A welding system including:
a welding device;
a visual sensor that images a welding operation by the welding device; and
a measuring device that measures a behavior of a welding phenomenon using a welding image imaged by the visual sensor,
wherein the measuring device includes:
   image processing means for carrying out, in accordance with a behavior of a welding phenomenon of interest, image processing with respect to the welding image;
   image division means for using the processed image that has been generated by the image processing means to generate a plurality of divided images for respective constituent elements corresponding to the welding phenomenon; and
   derivation means for using at least two divided images among the plurality of divided images to derive the behavior of the welding phenomenon.

According to this configuration, it is possible to measure a plurality of behaviors of welding phenomena occurring in the welding system based on a captured image imaged by the image sensor.

(13) A welding phenomenon behavior measuring device including:
image processing means for carrying out, in accordance with a behavior of a welding phenomenon of interest, image processing with respect to a welding image that has been imaged by a visual sensor;
image division means for using the processed image that has been generated by the image processing means to generate a plurality of divided images for respective constituent elements corresponding to the welding phenomenon; and
derivation means for using at least two divided images among the plurality of divided images to derive the behavior of the welding phenomenon.

According to this configuration, it is possible to measure a plurality of behaviors of welding phenomena based on a captured image imaged by the image sensor.

(14) A welding method including: controlling a welding operation based on the behavior of the welding phenomenon derived by the measuring device according to claim 13.

According to this configuration, it is possible to control the welding operation based on a plurality of behaviors of welding phenomena that have been measured.

(15) A welding phenomenon behavior measuring method including:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

According to this configuration, it is possible to measure a plurality of behaviors of welding phenomena in additive manufacturing based on a captured image imaged by the image sensor.

(16) A program for causing a computer to execute:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

According to this configuration, it is possible to measure a plurality of behaviors of welding phenomena based on a captured image imaged by the image sensor.

Although various embodiments have been described with reference to the drawings, it goes without saying that the present invention is not limited to such examples. It is obvious to those skilled in the art that various changes or modifications are conceivable within the scope of the claims, and it is understood that they also fall naturally within the technical scope of the present invention. Furthermore, within the scope that does not deviate from the spirit of the invention, the components of the above-described embodiments may be combined as desired.

Note that the present application is based on Japanese Patent Application (Japanese Patent Application No. 2021-118757) filed on Jul. 19, 2021, the contents of which are incorporated herein by reference.

### REFERENCE SIGNS LIST

1 welding system
10 welding robot
11 welding torch
12 wire feeding device
13 welding wire
20 robot control device
30 power supply
40 visual sensor
41 current sensor
42 voltage sensor
50 data processing device
201 CPU (Central Processing Unit)
202 memory
202A control program
203 operation panel
204 teaching pendant
205 robot connection unit
206 communication unit
501 storage unit
502 image processing unit
503 image division unit
504 calculation unit
505 display unit
506 visual sensor control unit

1. A welding phenomenon behavior measuring method comprising:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

2. The welding phenomenon behavior measuring method according to claim 1, wherein:
the constituent elements corresponding to the welding phenomenon include at least two of spatter, fumes, arc light, a molten pool, background, or an obstacle.

3. The welding phenomenon behavior measuring method according to claim 1, wherein:
the image division step comprises:
a labeling step for performing labeling processing on pixels included in the processed image; and
a classification step for classifying each of one or more regions composed of a group of pixels labeled in the labeling step into a constituent element corresponding to the welding phenomenon, and
the classification step comprises at least one of:
a step for classifying each of the one or more regions into a constituent element corresponding to the welding phenomenon based on pixel count;
a step for classifying each of the one or more regions into a constituent element corresponding to the welding phenomenon based on position and size; or
a step for classifying a region of interest into a constituent element corresponding to the welding phenomenon based on a ratio of a group of pixels constituting the region of interest to a rectangular region encompassing the region of interest.

4. The welding phenomenon behavior measuring method according to claim 1, wherein:
in the image division step, a divided image composed of a region of spatter and a divided image composed of a region of fumes are at least generated among the constituent elements corresponding to the welding phenomenon.

5. The welding phenomenon behavior measuring method according to claim 1, wherein:
in the derivation step, an indicator value of at least one of spatter or fumes is derived as the behavior of the welding phenomenon.

6. The welding phenomenon behavior measuring method according to claim 5, wherein, in the derivation step, in a case of deriving an indicator value of fumes,
an edge is detected for a divided image with a region of spatter removed,
the divided image is divided into a plurality of regions based on the detected edge, and
an indicator value of the fumes is calculated based on an area of the plurality of regions.

7. The welding phenomenon behavior measuring method according to claim 5, further comprising:
a setting step for setting a period to be measured,
wherein the image processing step, the image division step, and the derivation step are performed using a welding image included in a period set in the setting step.

8. The welding phenomenon behavior measuring method according to claim 1, wherein the image processing step includes at least one of processing to separate the welding image into images for respective color components, binarization processing, or processing to obtain or exclude smoothly fluctuating pixel values.

9. The welding phenomenon behavior measuring method according to claim 8, wherein, in the processing to separate the welding image into images for respective color components, color component images for respective color components of R, G, and B are generated from the welding image.

10. The welding phenomenon behavior measuring method according to claim 9, wherein an indicator value of at least one of arc light, spatter, or thick fumes is derived using the color component image of R.

11. The welding phenomenon behavior measuring method according to claim 9, wherein an indicator value of thin fumes is derived using the color component image of B.

12. A welding system comprising:
a welding device;
a visual sensor that images a welding operation by the welding device; and
a measuring device that measures a behavior of a welding phenomenon using a welding image imaged by the visual sensor,
wherein the measuring device comprises:
image processing means for carrying out, in accordance with a behavior of a welding phenomenon of interest, image processing with respect to the welding image;
image division means for using the processed image that has been generated by the image processing means to generate a plurality of divided images for respective constituent elements corresponding to the welding phenomenon; and
derivation means for using at least two divided images among the plurality of divided images to derive the behavior of the welding phenomenon.

13. A welding phenomenon behavior measuring device comprising:
image processing means for carrying out, in accordance with a behavior of a welding phenomenon of interest, image processing with respect to a welding image that has been imaged by a visual sensor;
image division means for using the processed image that has been generated by the image processing means to generate a plurality of divided images for respective constituent elements corresponding to the welding phenomenon; and
derivation means for using at least two divided images among the plurality of divided images to derive the behavior of the welding phenomenon.

14. A welding method comprising: controlling a welding operation based on the behavior of the welding phenomenon derived by the measuring device according to claim 13.

15. A welding phenomenon behavior measuring method comprising:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.

16. A non-transitory computer readable medium storing a program that, when executed by a computer, causes the computer to execute:
an image processing step for carrying out, in accordance with a behavior of a welding phenomenon of interest, image processing with respect to a welding image that has been imaged by a visual sensor;
an image division step for using the processed image that has been generated in the image processing step to generate a plurality of divided images for respective constituent elements corresponding to the welding phenomenon; and
a derivation step for using at least two divided images among the plurality of divided images to derive the behavior of the welding phenomenon.
